(19) United States
(12) Patent Application Publication
(10) Pub. No.: US 2006/0056169 A1
(43) Pub. Date: Mar. 16, 2006

(54) Light module using led clusters

(76) Inventors: Pervaiz Lodhie, Rolling Hills, CA (US); Lei U. Vinoya, Long Beach, CA (US); Steven R. Becerra, San Pedro, CA (US)

Correspondence Address: Irving Keschner, Suite 1150, 21515 Hawthorne Boulevard, Torrance, CA, 90503, US

(21) Appl. No.: 10/938,332

(22) Filed: Sep. 10, 2004

(51) Int. Cl. G09F 13/04

(52) U.S. Cl. 362/97; 362/231

(57) ABSTRACT

A streetlight wherein the conventional incandescent light bulb is replaced by sets of light-emitting LED clusters. The clusters comprise parallel circuits of LED bulbs mounted on a printed circuit board (PCB). Preferably, the configuration comprises ten clusters, each cluster having two parallel circuits of LEDs, each circuit having twenty LEDs. Each cluster may be connected separately to its own power source or a single power source can be used to power the entire set of clusters. The LED bulbs face downwards, and operate to disperse light directly onto the intended area of the road or street surface. The lamp is encased within a glass cover lens.

### BACKGROUND OF THE INVENTION

1. Field of the Invention

The present invention provides clusters of light-emitting LED bulbs formed in parallel circuits and mounted on a printed circuit board and designed to replace the conventional incandescent light bulbs utilized is streetlights to illuminate streets and other public areas.

2. Description of the Prior Art

Street lights and parking lot lights using incandescent light bulbs have been used to illuminate street and other public areas. Over the years, conventional street lights have been modified to provide functions other than illumination. For example, U.S. Pat. No. 6,624,845 to Loyd et al discloses an apparatus mounted within a street lamp to provide surveillance using a directional antenna. However, street lights and parking lot lights still use incandescent light bulbs with the resultant unwanted glare, light trespass, energy, waste and sky glow. An estimated thirty percent of light generated outdoors by the aforementioned lights goes into space, flooding the skies and creating electric haze that reduces stargazing.

What is desired is to provide a light module adapted for use in streetlights and parking lot lights such that the illumination generated by the module is emitted in the direction needed i.e. at ground level thus reducing the amount of light lost to the sky while improving overall nighttime viewing.

### SUMMARY OF THE INVENTION

The present invention provides a light module using LED clusters that reduces the power consumption of the lamp (approximately 25 watts) while providing the desired direction for the emitted light.

The clusters comprise parallel rows of LED bulbs mounted on a printed circuit board (PCB). Preferably, the configuration comprises ten clusters, each cluster having two parallel rows of LEDs, each row having twenty LEDs. Each cluster may be connected separately to a power source or a single power source can be used to power the entire LED cluster.

The lamp emanates high-intensity light with enhanced purity of color while at the same time reducing light pollution. The preferred LED generates incandescent-white color, but LEDs that generate red, orange, yellow, cool white, green and blue colors can also be used.

The light acts as an efficient, low maintenance and substantial power saving substitute for now widely used incandescent light bulbs for illumination of streets, parking lots and other public areas, requiring minimal wiring modification to the conventional streetlight or parking lot housings.

### DESCRIPTION OF THE DRAWINGS

For a better understanding of the present invention as well as other objects and further features thereof, reference is made to the following description which is to be read in conjunction with the accompanying drawing wherein:

FIG. 1 illustrates a bottom perspective view of the streetlight in which the present invention is utilized;

FIG. 2 is a bottom plan view of the street light shown in FIG. 1;

FIG. 3 is a cross-sectional view along line 3-3 of FIG. 1;

FIG. 4 is a detail of a portion of the streetlight shown in FIG. 3;

FIG. 5 is a cross-section along line 5-5 of FIG. 3;

FIG. 6 is a side view of the streetlamp and the associated mounting bracket;

FIG. 7 is a top view of the mounting bracket;

FIG. 8 is a rear view of the mounting bracket;

FIG. 9 is a side view of the streetlight incorporating the light module of the present invention;

FIG. 10 is a front view of the streetlight incorporating the light module of the present invention; and

FIG. 11 is a schematic diagram illustrating power connections to the LED clusters.

### DESCRIPTION OF THE INVENTION

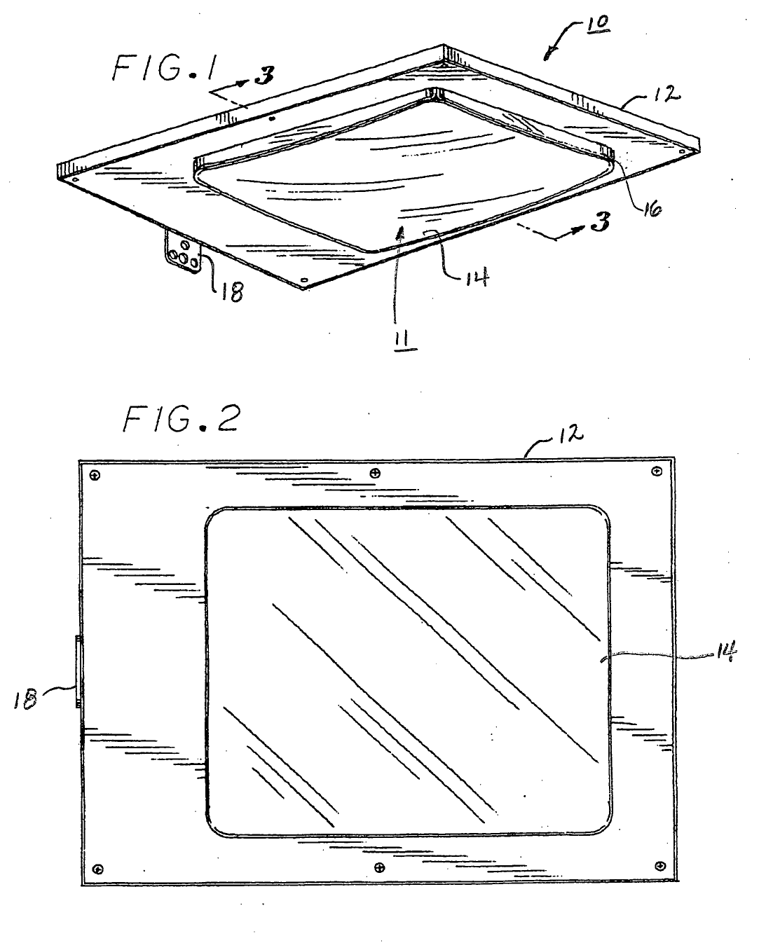

Referring now to FIGS. 1 and 2, a streetlight head 10 incorporating the light module 11 of the present invention is illustrated. Streetlight head 10 comprises base 12, light transmissive lens, or cover, 14, support 16 and bracket 18. It should be noted that light module 11 can be easily retrofitted into existing streetlights in addition to being used with a new streetlight.

The shape of the streetlight head 10 is that of a “shoebox”; other shapes are possible such as the “cobra” type streetlights currently available.

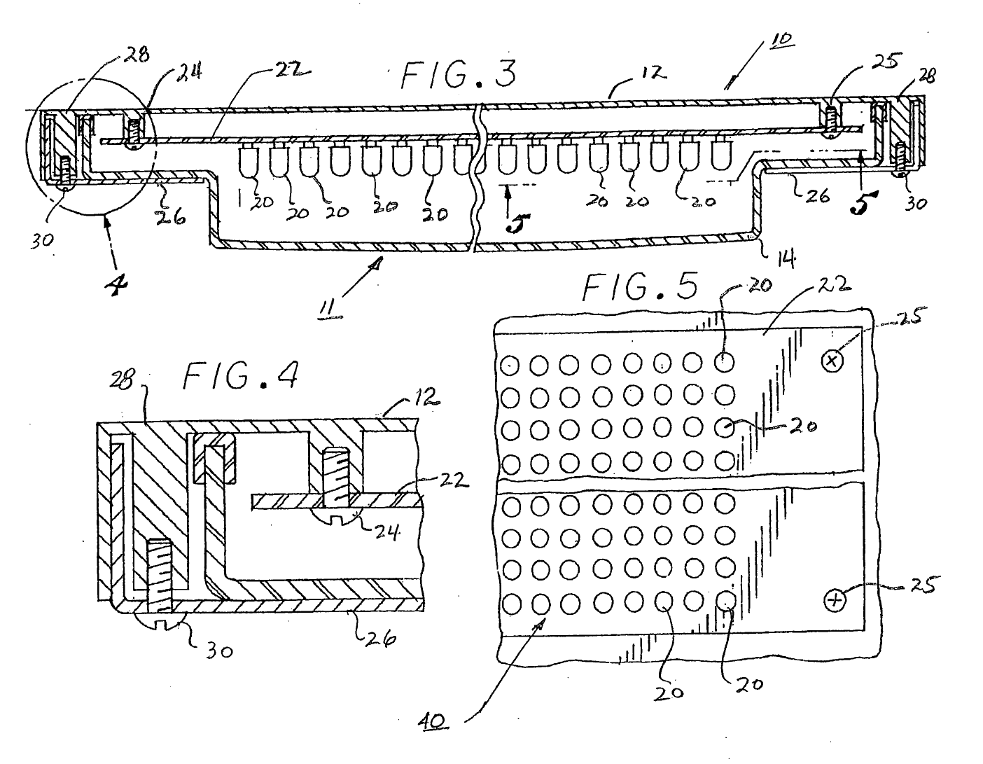

FIG. 3 is a view showing the interior portion of light module 11. A plurality of light emitting diodes (“LEDs”) 20 are mounted to a printed circuit board 22. Printed circuit board 22 is connected to base 12 by screws 24 and 25 as illustrated. A gasket 26, preferably made of rubber, is positioned around the edge of lens 14 and secured to frame plate 28 by screw 30, screw 30 maintaining pressure on lens 14. The LEDs 20 are mounted in a downward direction in a manner to disperse light directly onto the intended area of the road or street surface.

FIG. 5 shows a portion of the LED array 40 forming the light module 11 portion of streetlight head 10. The array comprises a plurality of LEDs 20 connected in a predetermined manner. In a preferred embodiment, the array comprises 400 LEDs connected in ten parallel circuits of 40 series connected LEDs.

FIG. 6 is a side view of streetlight head 10 with mounting bracket 18 and associated power cord 42.

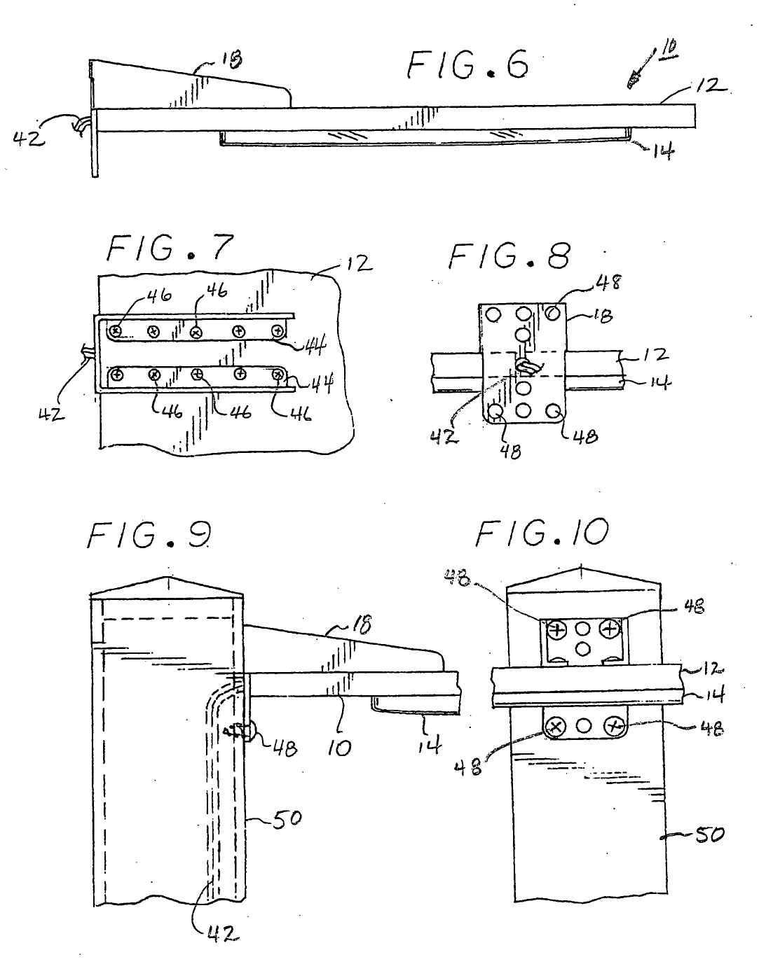

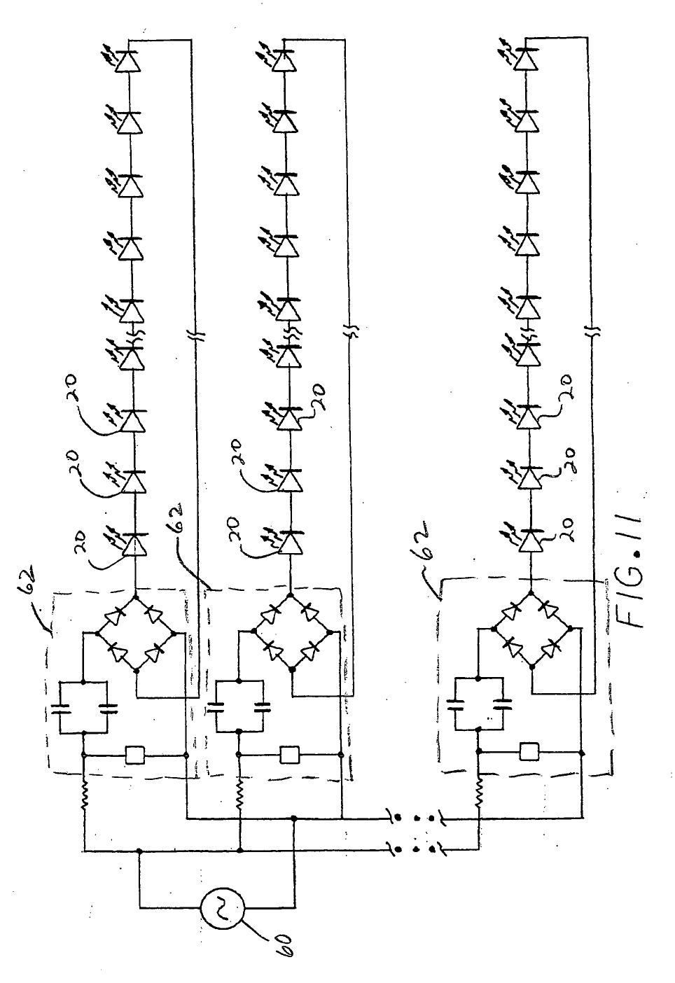

FIG. 7 is a top view of bracket 18 showing bracket lip portions 44 with screws 46 for joining base 12 to the bracket; FIG. 8 is a rear view of bracket 18 having screws 48 to mount bracket 18 to vertically extending light pole 50 (FIG. 9) and FIG. 10 is a front view of the streetlight head 10 mounted to pole 58.

It should be noted that although the preferred embodiment is to mount streetlight head 10 to vertically extending pole 50, streetlight head 10 may be flush mounted to a ceiling or wall. Further, streetlight head 10, in combination with pole 50, forms the streetlight or parking lot light which is used to illuminate a surface in accordance with the teachings of the present invention.

FIG. 11 is a partial schematic diagram for the electrical connections to the LED array mounted within the streetlight head 10 (although only 9 LEDs are in the three parallel rows illustrated, in the preferred embodiment forty LEDs are connected in serial in ten parallel circuits). In particular, a single AC source 60 (typically provided by a municipality or developer) is coupled to circuitry 62 which converts the AC signal to a filtered AC signal which in turn is applied to the LEDs 20, causing the LEDs to emit the particular color associated therewith. It should be noted that streetlight head 10, in the shoebox shape, or the conventional cobra shape, is connected to the power source 60 in a conventional manner. Although a single power source 60 is illustrated, if necessary separate power sources can be used to power each cluster, or parallel circuit illustrated.

The streetlight head 10 utilizing light module 11 of the present invention provides better visibility, requires less power, utilizes a longer lived light source, mounts on standard lamp posts, reduces light pollution and emits light of various colors depending upon the selected LED, such as incandescent-white, amber, yellow, red, green, blue, infrared and ultraviolet.

While the invention has been described with reference to its preferred embodiments, it will be understood by those skilled in the art that various changes may be made and equivalents may be substituted for elements thereof without departing from the true spirit and scope of the invention. In addition, many modifications may be made to adapt a particular situation or material to the teachings of the invention without departing from its essential teachings.

What is claimed is:

1. A light module for generating illumination, the emitted illumination being in a first direction comprising:
a vertically extending support member;
means for securing said light module to said support member, said light module containing arrays of light emitting diodes supported therein; and
means for energizing said light emitting diodes.

2. The light module of claim 1 wherein said light emitting diodes are formed in separate clusters, each separate cluster being coupled to said energizing means.

3. The light module of claim 2 wherein each cluster comprises two parallel rows of light emitting diodes.

4. The ligh module of claim 3 wherein said arrays of light emitting diodes are enclosed by a cover member transmissive of the light emitted by said light emitting diodes.

5. The ligh module of claim 4 wherein said light emitting diodes are positioned within said lighting module such that the light emitted thereby is transmitted through said cover member.
